(19) United States
(12) Patent Application Publication
(10) Pub. No.: US 2017/0089433 A1
(43) Pub. Date: Mar. 30, 2017

(54) CARRIER FOR BALL-TYPE CONTINUOUSLY VARIABLE TRANSMISSION

(71) Applicant: Dana Limited, Maumee, OH (US)

(72) Inventors: Gregory STEVENSON, Austin, TX (US); Ryan D. NELMS, Austin, TX (US)

(21) Appl. No.: 15/260,472

(22) Filed: Sep. 9, 2016

Related U.S. Application Data
(60) Provisional application No. 62/222,956, filed on Sep. 24, 2015.

(51) Int. Cl. F16H 15/50; F16H 57/08; F16H 57/04

(52) U.S. Cl. CPC F16H 15/503; F16H 57/043; F16H 57/0479; F16H 57/0484; F16H 57/082; F16H 57/0487

(57) ABSTRACT

Provided herein is a carrier assembly for a continuously variable transmission having a plurality of balls, each having a tiltable axis of rotation, a first traction ring assembly in contact with each ball, a second traction ring assembly in contact with each ball, the carrier assembly having a carrier manifold member with a plurality of guide slots, each guide slot adapted to operably couple to, and provide support to each ball, the carrier manifold member having a number of lubrication channels, each lubrication channel located radially between each guide slot; and a flange cap member operably coupled to the carrier manifold member. In one embodiment, the carrier assembly is provided with a number of orifice channels. The orifice channels are adapted to deliver a spray of pressurized fluid to internal components of the continuously variable transmission. The orifice channels are formed between the carrier manifold member and the flange cap member.

### CROSS-REFERENCE

The present application claims priority to U.S. Provisional Patent Application No. 62/222,956, filed Sep. 24, 2015, which is incorporated herein by reference in its entirety.

### BACKGROUND OF THE INVENTION

Automatic and manual transmissions are commonly used on automobiles. Such transmissions have become more and more complicated since the engine speed has to be adjusted to limit fuel consumption and the emissions of the vehicle. A vehicle having a driveline including a tilting ball variator allows an operator of the vehicle or a control system of the vehicle to vary a drive ratio in a stepless manner. A variator is an element of a Continuously Variable Transmission (CVT) or an Infinitely Variable Transmission (IVT). Transmissions that use a variator can decrease the transmission's gear ratio as engine speed increases. This keeps the engine within its optimal efficiency while gaining ground speed, or trading speed for torque during hill climbing, for example. Efficiency in this case can be fuel efficiency, decreasing fuel consumption and emissions output, or power efficiency, allowing the engine to produce its maximum power over a wide range of speeds. That is, the variator keeps the engine turning at constant RPMs over a wide range of vehicle speeds.

### SUMMARY OF THE INVENTION

Over time packaging of transmission components has become an ever increasing issue. As with most parts of a transmission, there is a desire to reduce weight, number and size of components to improve efficiency. The carrier of a variator is made up of multiple pieces to facilitate ease of manufacture and provide adequate lubrication for traction contacts and cooling of traction rings. Due to tight packaging requirements for lubrication channels within the variator, an improved carrier design is required to facilitate a path for lubrication fluid to route from the main shaft through the carrier and to target the leading and trailing edges of the traction rings with an efficient spray pattern.

Provided herein is a carrier assembly for a continuously variable ball planetary transmission having a plurality of balls, each having a tiltable axis of rotation, a first traction ring assembly in contact with each ball, a second traction ring assembly in contact with each ball, the carrier assembly comprising: a carrier manifold member having a plurality of guide slots, each guide slot adapted to operably couple to, and provide support for, each ball, the carrier manifold member having a number of lubrication channels, each lubrication channel located radially between each guide slot; and a flange cap member operably coupled to the carrier manifold member.

In some embodiments of the carrier assembly, the carrier manifold member comprises a plurality of orifice cavities, each orifice cavity connected to each lubrication channel.

In some embodiments of the carrier assembly, the carrier manifold member comprises a plurality of orifice cavity entrances, each orifice cavity entrance connecting the lubrication channel to the orifice cavity.

In some embodiments of the carrier assembly, the flange cap member is provided with a plurality of mounting faces, each mounting face adapted to couple to, and substantially align with, each orifice cavity.

In some embodiments of the carrier assembly, a plurality of fasteners are provided , wherein the flange cap member is adapted to receive each fastener on each mounting face, and wherein the carrier member is provided with a number of openings, each opening adapted to provide clearance for the fastener.

In some embodiments of the carrier assembly, an orifice channel is located between the flange cap member and the carrier manifold member.

In some embodiments of the carrier assembly, the guide slots are radially offset.

Provided herein is a carrier manifold member for a continuously variable transmission, the carrier manifold member having a body, the carrier manifold member comprising: a plurality of guide slots arranged radially on the body; a plurality of lubrication channels arranged radially on the interior of the body, each lubrication channel located substantially between each guide slot; and a plurality of orifice cavities located radially outward of the lubrication channels.

In some embodiments of the carrier manifold member, a plurality of orifice cavity entrances are provided, each orifice cavity entrance coupled to the lubrication channel, each orifice cavity entrance coupled to the orifice cavity.

In some embodiments of the carrier manifold member, the orifice cavity entrance is smaller than the orifice cavity.

In some embodiments of the carrier manifold member, a plurality of openings are provided, each opening located between the lubrication channel and the orifice cavity entrance, the opening adapted to provide a clearance for a fastener.

In some embodiments of the carrier manifold member, the guide slots are radially offset.

Provided herein is a continuously variable transmission having a plurality of balls, each having a tiltable axis of rotation, a first traction ring assembly in contact with each ball, a second traction ring assembly in contact with each ball, the continuously variable transmission comprising: a main shaft arranged along the longitudinal axis of the transmission, the main shaft provided with a lubrication channel arranged along an interior axis of the main shaft; a first carrier assembly operably coupled to the main shaft, the carrier assembly adapted to receive a pressurized fluid from the main shaft, the first carrier assembly comprising: a carrier manifold member having a plurality of guide slots, each guide slot adapted to operably couple to, and provide support to, each ball, the carrier manifold member having a number of lubrication channels, each lubrication channel located radially between each guide slot; and a flange cap member operably coupled to the carrier manifold member.

In some embodiments of the continuously variable transmission, the carrier manifold member comprises a plurality of orifice cavities, each orifice cavity connected to each lubrication channel.

In some embodiments of the continuously variable transmission, the carrier manifold member comprises a plurality of orifice cavity entrances, each orifice cavity entrance connecting the lubrication channel to the orifice cavity.

In some embodiments of the continuously variable transmission, the flange cap member is provided with a plurality of mounting faces, each mounting face adapted to couple to, and substantially align with, each orifice cavity.

In some embodiments of the continuously variable transmission, a plurality of fasteners, wherein the flange cap member is adapted to receive each fastener on each mounting face, and wherein the carrier manifold member is provided with a number of openings, each opening adapted to provide clearance for the fastener.

In some embodiments of the continuously variable transmission, an orifice channel located between the flange cap member and the carrier manifold member.

In some embodiments of the continuously variable transmission, a second carrier assembly operably coupled to the first carrier assembly, the second carrier assembly adapted to rotate with respect to the first carrier assembly.

In some embodiments of the continuously variable transmission, the second carrier assembly comprises: a second carrier manifold member having a plurality of guide slots, each guide slot adapted to operably couple to, and provide support to, each ball, the carrier manifold member having a number of lubrication channels, each lubrication channel located radially between each guide slot; and a second flange cap member operably coupled to the carrier manifold member.

In some embodiments of the continuously variable transmission, the second carrier manifold member comprises a plurality of orifice cavities, each orifice cavity connected to each lubrication channel.

In some embodiments of the continuously variable transmission, the second carrier manifold member comprises a plurality of orifice cavity entrances, each orifice cavity entrance connecting the lubrication channel to the orifice cavity.

In some embodiments of the continuously variable transmission, the second flange cap member is provided with a plurality of mounting faces, each mounting face adapted to couple to, and substantially align with, each orifice cavity.

In some embodiments of the continuously variable transmission, a plurality of fasteners are provided, wherein the second flange cap member is adapted to receive each fastener on each mounting face, and wherein the second carrier manifold member is provided with a number of openings, each opening adapted to provide clearance for the fastener.

In some embodiments of the continuously variable transmission, a second orifice channel is located between the second flange cap member and the second carrier manifold member.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that can be used in the variator of FIG. 1.

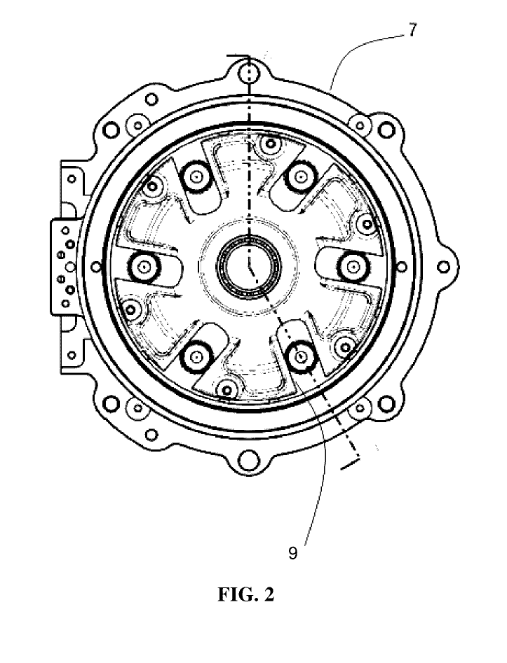

FIG. 3 is an illustrative view of different tilt positions of the ball-type variator of FIG. 1.

FIG. 4 is a partial cross-section view of a ball-type variator having a carrier assembly.

FIG. 5 is a plan view of a carrier assembly used in the ball-type variator of FIG. 4.

FIG. 6 is a cross-section view of a carrier assembly used in the ball-type variator of FIG. 4.

FIG. 7 is a cross sectional detail view of the carrier assembly used in the ball-type variator of FIG. 4.

FIG. 8 is an exploded view of the carrier assembly used in the ball-type variator of FIG. 4.

FIG. 9 is a plan view of a carrier manifold member that can be used in the carrier assembly of FIG. 5.

FIG. 10 is a detail view of the carrier manifold member of FIG. 9.

### DETAILED DESCRIPTION OF THE INVENTION

This invention relates to components that can be used in a ball planetary style continuously variable transmission, such as the VariGlide®, in order to provide lubrication and cooling to internal components of the transmission.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention can include several novel features, no single one of which is solely responsible for its desirable attributes or which is essential to practicing the inventions described.

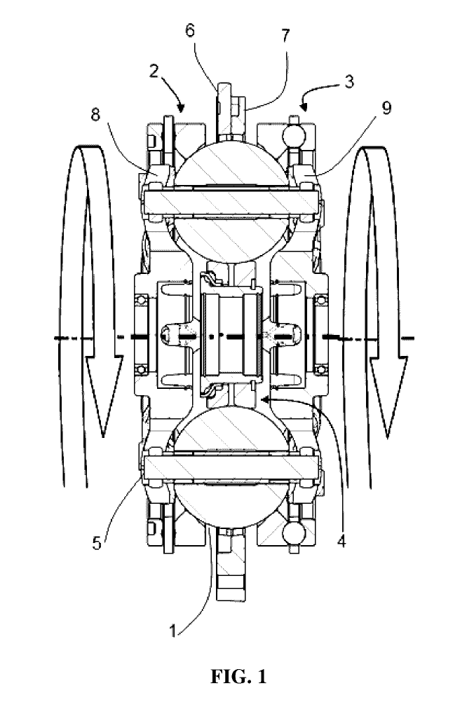

Provided herein are configurations of CVTs based on a ball type variators, also known as CVP, for continuously variable planetary. Basic concepts of a ball type Continuously Variable Transmissions are described in U.S. Pat. No. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member, and vice versa. In one embodiment, the first carrier member 6 can be provided with a number of radial guide slots 8. The second carrier member 7 can be provided with a number of radially offset guide slots 9. The radial guide slots 8 and the radially offset guide slots 9 are adapted to guide the tiltable axles 5. The axles 5 can be adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

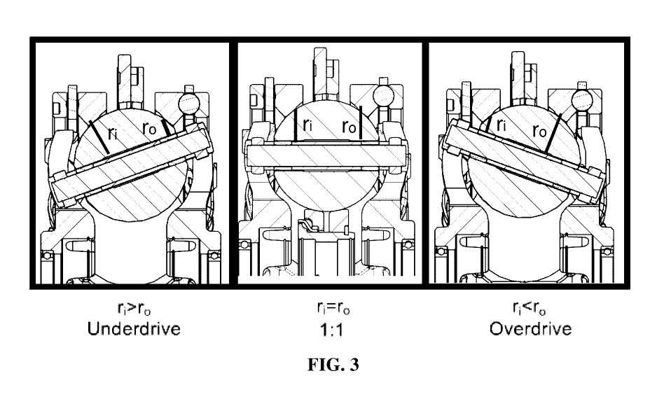

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

As used herein, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, lubrication passage 19A and lubrication passage 19B) will be referred to collectively by a single label (for example, lubrication passage 19).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT can operate at times as a friction drive and at other times as a traction drive, depending on the torque and speed conditions present during operation.

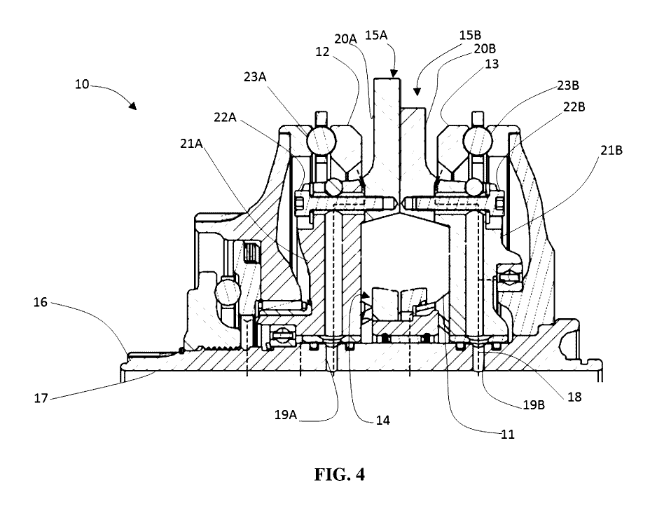

Referring now to FIG. 4, in one embodiment, in one embodiment a continuously variable planetary (CVP) 10 can include a plurality of balls 11, each ball having a tiltable axis of rotation, each ball in contact with a first traction ring 12, a second traction ring 13, and an idler assembly 14. The idler assembly 14 located radially inward of each ball 11, the first traction ring 12, and the second traction ring 13. Each ball 11 is operably coupled to a carrier assembly 15. In one embodiment, the carrier assembly 15 can include a first carrier subassembly 15A and a second carrier subassembly 15B. The first carrier subassembly 15A can be adapted to rotate relative to the second carrier subassembly 15B to facilitate a change in operating condition of the CVP 10. In one embodiment, the carrier subassembly 15 can be operably coupled to a shift actuator (not shown). The CVP 10 is provided with a main shaft 16 positioned along the longitudinal axis. The main shaft 16 is operably coupled to the carrier assembly 15. The main shaft 16 is provided with a lubrication channel 17 located in the interior and positioned along the longitudinal axis. The lubrication channel 17 can be configured to deliver a pressurized fluid, such as transmission oil, to internal components of the CVP 10. For illustrative purposes, dashed lines 18 depicted in FIG. 4 represent fluid flow within the interior of the CVP 10. The main shaft 15 is configured to be in fluid communication with the carrier assembly 15. For example, the main shaft 15 can be provided with passages 19 that are configured to deliver a pressurized fluid to the carrier assembly 15.

Provided herein is a continuously variable transmission having a plurality of balls, each having a tiltable axis of rotation, a first traction ring assembly in contact with each ball, a second traction ring assembly in contact with each ball, the continuously variable transmission comprising: a main shaft arranged along the longitudinal axis of the transmission, the main shaft provided with a lubrication channel arranged along an interior axis of the main shaft; a first carrier assembly operably coupled to the main shaft, the carrier assembly adapted to receive a pressurized fluid from the main shaft, the first carrier assembly comprising: a carrier manifold member having a plurality of guide slots, each guide slot adapted to operably couple to, and provide support to, each ball, the carrier manifold member having a number of lubrication channels, each lubrication channel located radially between each guide slot; and a flange cap member operably coupled to the carrier manifold member.

In some embodiments of the continuously variable transmission, the carrier manifold member comprises a plurality of orifice cavities, each orifice cavity connected to each lubrication channel.

In some embodiments of the continuously variable transmission, the carrier manifold member comprises a plurality of orifice cavity entrances, each orifice cavity entrance connecting the lubrication channel to the orifice cavity.

In some embodiments of the continuously variable transmission, the flange cap member is provided with a plurality of mounting faces, each mounting face adapted to couple to, and substantially align with, each orifice cavity.

In some embodiments of the continuously variable transmission, a plurality of fasteners, wherein the flange cap member is adapted to receive each fastener on each mounting face, and wherein the carrier manifold member is provided with a number of openings, each opening adapted to provide clearance for the fastener.

In some embodiments of the continuously variable transmission, an orifice channel located between the flange cap member and the carrier manifold member.

In some embodiments of the continuously variable transmission, a second carrier assembly operably coupled to the first carrier assembly, the second carrier assembly adapted to rotate with respect to the first carrier assembly.

In some embodiments of the continuously variable transmission, the second carrier assembly comprises: a second carrier manifold member having a plurality of guide slots, each guide slot adapted to operably couple to, and provide support to, each ball, the carrier manifold member having a number of lubrication channels, each lubrication channel located radially between each guide slot; and a second flange cap member operably coupled to the carrier manifold member.

In some embodiments of the continuously variable transmission, the second carrier manifold member comprises a plurality of orifice cavities, each orifice cavity connected to each lubrication channel.

In some embodiments of the continuously variable transmission, the second carrier manifold member comprises a plurality of orifice cavity entrances, each orifice cavity entrance connecting the lubrication channel to the orifice cavity.

In some embodiments of the continuously variable transmission, the second flange cap member is provided with a plurality of mounting faces, each mounting face adapted to couple to, and substantially align with, each orifice cavity.

In some embodiments of the continuously variable transmission, a plurality of fasteners are provided, wherein the second flange cap member is adapted to receive each fastener on each mounting face, and wherein the second carrier manifold member is provided with a number of openings, each opening adapted to provide clearance for the fastener.

In some embodiments of the continuously variable transmission, a second orifice channel is located between the second flange cap member and the second carrier manifold member.

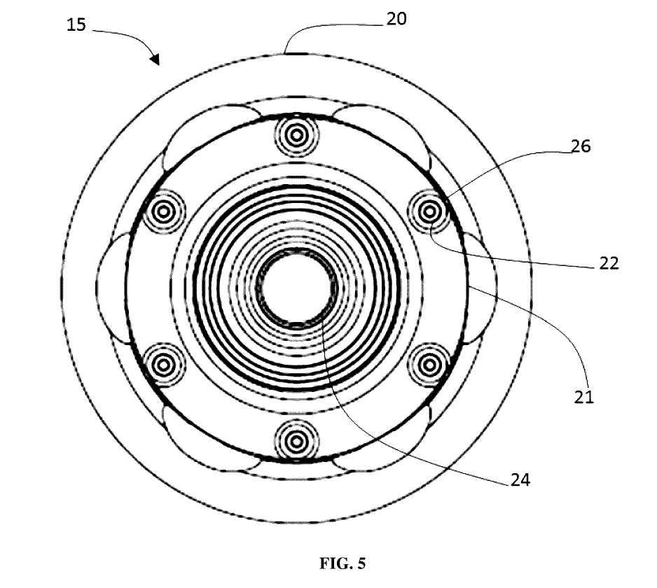

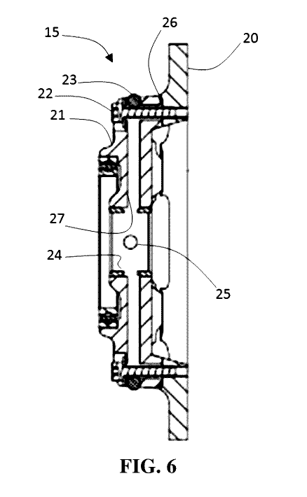

Turning now to FIGS. 5-6 and referring still to FIG. 4, in one embodiment the carrier assembly 15 can include a flange cap member 20 coupled to a carrier manifold member 21 with a number of fasteners 22. The fasteners 22 can be bolts, for example. The carrier manifold member 21 can be provided with a number of plugs 23. The carrier assembly 15 can include a collar 24. The collar 24 has a number of passages 25. The passages 25 can facilitate delivery of a pressurized fluid from the main shaft 16 to the carrier assembly 15. The interface between the flange cap member 20 and the carrier manifold member 21 form an orifice channel 26. The orifice channel 26 is connected to a fluid channel 27. The fluid channel 27 is located on the interior of the carrier manifold member 21. The fluid channel 27 is formed radially in the carrier manifold member 21. The fluid channel 27 has an opening located at a radially inward location and a second end connected to the orifice channel 26 at a radially outward location.

Provided herein is a carrier assembly for a continuously variable transmission having a plurality of balls, each having a tiltable axis of rotation, a first traction ring assembly in contact with each ball, a second traction ring assembly in contact with each ball, the carrier assembly comprising: a carrier manifold member having a plurality of guide slots, each guide slot adapted to operably couple to, and provide support to each ball, the carrier manifold member having a number of lubrication channels, each lubrication channel located radially between each guide slot; and a flange cap member operably coupled to the carrier manifold member.

In some embodiments of the carrier assembly, the carrier manifold member comprises a plurality of orifice cavities, each orifice cavity connected to each lubrication channel.

In some embodiments of the carrier assembly, the carrier manifold member comprises a plurality of orifice cavity entrances, each orifice cavity entrance connecting the lubrication channel to the orifice cavity.

In some embodiments of the carrier assembly, the flange cap member is provided with a plurality of mounting faces, each mounting face adapted to couple to, and substantially align with, each orifice cavity.

In some embodiments of the carrier assembly, a plurality of fasteners are provided , wherein the flange cap member is adapted to receive each fastener on each mounting face, and wherein the carrier member is provided with a number of openings, each opening adapted to provide clearance for the fastener.

In some embodiments of the carrier assembly, an orifice channel is located between the flange cap member and the carrier manifold member.

In some embodiments of the carrier assembly, the guide slots are radially offset.

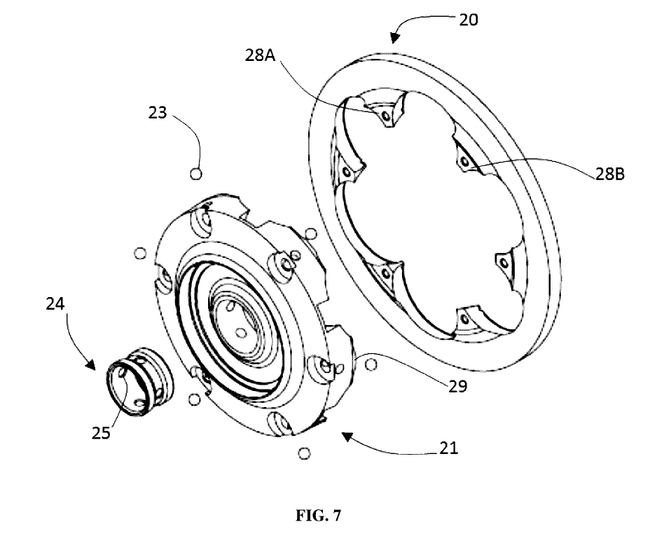

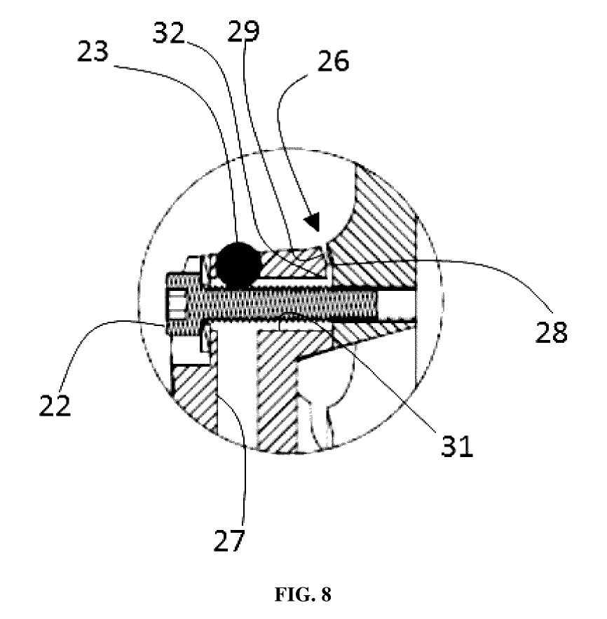

Referring now to FIGS. 7-8, in one embodiment the flange cap member 20 can be configured with a number of mounting faces 28. Each mounting face 28 is adapted to couple to, and substantially align with, the fasteners 22. The carrier manifold member 21 can be provided with a number of orifice cavities 29. Each orifice cavity can be coupled to, and substantially aligned with, each mounting face 28. Upon assembly of the carrier assembly 15, the mounting face 28 and the orifice cavity 29 form the orifice channel 26. In one embodiment the orifice channel 26 can be arranged in the carrier assembly 15 to be substantially located between balls 11.

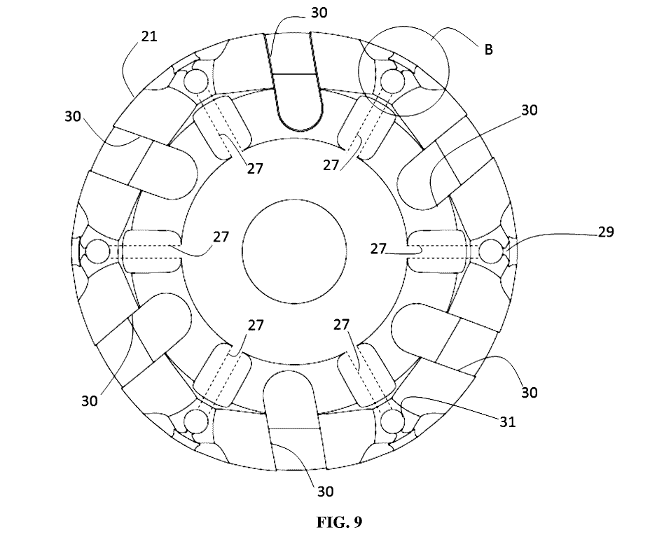

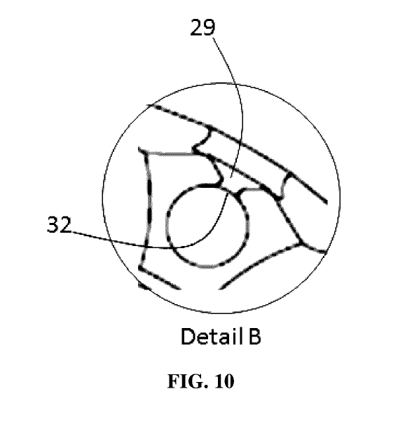

Turning now to FIGS. 9-10, and still referring to FIG. 8, in one embodiment the carrier manifold member 21 can be provided with a number of guide slots 30. Each guide slot 30 is adapted to operably couple to the balls 11. The guide slots 30 can be grooves formed in the body of the carrier manifold 21. In some embodiments, the guide slots 30 are radially offset to facilitate shifting the CVP 10. In one embodiment, the fluid channels 27 are formed radially between the guide slots 30. The fluid channels 27 are connected to a number of openings 31. The openings 31 are configured to provide a clearance passage for the fasteners 22. The clearance passage openings 31 facilitate the delivery of a pressurized fluid to the orifice cavity 29. In one embodiment, the orifice cavity 29 is formed as a pocket on the body of the carrier member 21. The orifice cavity 29 has an orifice cavity entrance 32. It should be noted that the orifice cavity entrance and the orifice cavity 29 can be shaped and appropriately sized to impart a desirable fluid spray pattern during operation of the CVP 10. For example, a pressurized fluid can be delivered through the carrier manifold member 21 and exit through the orifice cavity entrance 32. The fluid can form a spray that impacts the first traction ring 12 and the second traction ring 13. In one embodiment, it may be desirable for the spray to impact the contact between the first traction ring 12 and/or the second traction ring 13, and the balls 11. In some embodiments, the fluid channels 27 can include a number of lubrication channels that are adapted to supply a pressurized fluid to internal components of the CVP 10, such as, the idler assembly 14.

Provided herein is a carrier manifold member for a continuously variable transmission, the carrier manifold member having a body, the carrier manifold member comprising: a plurality of guide slots arranged radially on the body; a plurality of lubrication channels arranged radially on the interior of the body, each lubrication channel located substantially between each guide slot; and a plurality of orifice cavities located radially outward of the lubrication channels.

In some embodiments of the carrier manifold member, a plurality of orifice cavity entrances are provided, each orifice cavity entrance coupled to the lubrication channel, each orifice cavity entrance coupled to the orifice cavity

In some embodiments of the carrier manifold member, the orifice cavity entrance is smaller than the orifice cavity.

The carrier manifold member, further comprising a plurality of openings, each opening located between the lubrication channel and the orifice cavity entrance, the opening adapted to provide a clearance for a fastener.

In some embodiments of the carrier manifold member, the guide slots are radially offset.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A carrier assembly for a continuously variable transmission having a plurality of balls, each having a tiltable axis of rotation, a first traction ring assembly in contact with each ball, a second traction ring assembly in contact with each ball, the carrier assembly comprising: a carrier manifold member having a plurality of guide slots, each guide slot adapted to operably couple to, and provide support to, each ball, the carrier manifold member having a number of lubrication channels, each lubrication channel located radially between each guide slot; and
a flange cap member operably coupled to the carrier manifold member.

2. The carrier assembly of claim 1, wherein the carrier manifold member comprises a plurality of orifice cavities, each orifice cavity connected to each lubrication channel.

3. The carrier assembly of claim 2, wherein the carrier manifold member comprises a plurality of orifice cavity entrances, each orifice cavity entrance connecting the lubrication channel to the orifice cavity.

4. The carrier assembly of claim 3, wherein the flange cap member is provided with a plurality of mounting faces, each mounting face adapted to couple to, and substantially align with, each orifice cavity.

5. The carrier assembly of claim 4, further comprising a plurality of fasteners, wherein the flange cap member is adapted to receive each fastener on each mounting face, and wherein the carrier member is provided with a number of openings, each opening adapted to provide clearance for the fastener.

6. The carrier assembly of claim 1, further comprising an orifice channel located between the flange cap member and the carrier manifold member.

7. The carrier assembly of claim 1, wherein the guide slots are radially offset.

8. A carrier manifold member for a continuously variable transmission, the carrier manifold member having a body, the carrier manifold member comprising:
a plurality of guide slots arranged radially on the body;
a plurality of lubrication channels arranged radially on the interior of the body, each lubrication channel located substantially between each guide slot; and
a plurality of orifice cavities located radially outward of the lubrication channels.

9. The carrier manifold member of claim 8, further comprising a plurality of orifice cavity entrances, each orifice cavity entrance coupled to the lubrication channel, and each orifice cavity entrance coupled to the orifice cavity.

10. The carrier manifold member of claim 9, wherein the orifice cavity entrance is smaller than the orifice cavity.

11. The carrier manifold member of claim 9, further comprising a plurality of openings, each opening located between the lubrication channel and the orifice cavity entrance, the opening adapted to provide a clearance for a fastener.

12. The carrier manifold member of claim 8, wherein the guide slots are radially offset.

13. A continuously variable transmission having a plurality of balls, each having a tiltable axis of rotation, a first traction ring assembly in contact with each ball, a second traction ring assembly in contact with each ball, the continuously variable transmission comprising:
a main shaft arranged along the longitudinal axis of the transmission, the main shaft provided with a lubrication channel arranged along an interior axis of the main shaft;
a first carrier assembly operably coupled to the main shaft, the carrier assembly adapted to receive a pressurized fluid from the main shaft, the first carrier assembly comprising:
a carrier manifold member having a plurality of guide slots, each guide slot adapted to operably couple to, and provide support to each ball, the carrier manifold member having a number of lubrication channels, each lubrication channel located radially between each guide slot; and
a flange cap member operably coupled to the carrier manifold member.

14. The continuously variable transmission of claim 13, wherein the carrier manifold member comprises a plurality of orifice cavities, each orifice cavity connected to each lubrication channel.

15. The continuously variable transmission of claim 14, wherein the carrier manifold member comprises a plurality of orifice cavity entrances, each orifice cavity entrance connecting the lubrication channel to the orifice cavity.

16. The continuously variable transmission of claim 15, wherein the flange cap member is provided with a plurality of mounting faces, the mounting faces adapted to couple to, and substantially align with each orifice cavity.

17. The continuously variable transmission of claim 16, further comprising a plurality of fasteners, wherein the flange cap member is adapted to receive each fastener on each mounting face, and wherein the carrier manifold member is provided with a number of openings, each opening adapted to provide clearance for the fastener.

18. The continuously variable transmission of claim 17, further comprising an orifice channel located between the flange cap member and the carrier manifold member.

19. The continuously variable transmission of claim 13, further comprising a second carrier assembly operably coupled to the first carrier assembly, the second carrier assembly adapted to rotate with respect to the first carrier assembly.

20. The continuously variable transmission of claim 19, wherein the second carrier assembly comprises:
a second carrier manifold member having a plurality of guide slots, each guide slot adapted to operably couple to, and provide support to each ball, the carrier manifold member having a number of lubrication channels, each lubrication channel located radially between each guide slot;
a second flange cap member operably coupled to the carrier manifold member;
a plurality of fasteners, wherein the second flange cap member is adapted to receive each fastener on each mounting face, and wherein the second carrier manifold member is provided with a number of openings, each opening adapted to provide clearance for the fastener; and
a second orifice channel located between the second flange cap member and the second carrier manifold member;
wherein the second carrier manifold member comprises a plurality of orifice cavities, each orifice cavity connected to each lubrication channel,
wherein the second carrier manifold member comprises a plurality of orifice cavity entrances, each orifice cavity entrance connecting the lubrication channel to the orifice cavity, and
wherein the second flange cap member is provided with a plurality of mounting faces, each mounting face adapted to couple to, and substantially align with each orifice cavity.
